(19) United States
(12) Patent Application Publication
(10) Pub. No.: US 2011/0118110 A1
(43) Pub. Date: May 19, 2011

(54) CATALYST AND PROCESS FOR PRODUCING IT AND ITS USE

(75) Inventors: Stefan Kotrel, Bedminster, NJ (US); Gerhard Cox, Bad Duerkheim (DE); Ekkehard Schwab, Neustadt (DE); Alexander Panchenko, Ludwigshafen (DE)

(73) Assignee: BASF SE, Ludwigshafen (DE)

(21) Appl. No.: 12/674,909

(22) PCT Filed: Aug. 1, 2008
(86) PCT No.: PCT/EP08/60120

§ 371 Date: Feb. 24, 2010

(30) Foreign Application Priority Data
Aug. 24, 2007 (EP) 07114978.5

(51) Int. Cl. B01J 23/89; B01J 23/46; B01J 23/44; B01J 21/18; B01J 37/08; B01J 37/03; B82Y 30/00; B82Y 40/00

(52) U.S. Cl. 502/184; 502/326; 502/339; 502/331; 502/185; 977/810; 977/896

(57) ABSTRACT

The invention relates to a catalyst comprising an alloy of at least two different metals of which at least one metal is a metal of transition group VIII. The alloy is present in at least two phases having different degrees of alloying. The invention further relates to a process for producing the catalyst and a use of the catalyst.

The invention relates to a catalyst comprising an alloy of at least two different metals of which at least one metal is a metal of transition group VIII of the Periodic Table of the Elements according to the old designation. The invention further relates to a process for producing the catalyst and its use.

Fuel cells are energy transformers which convert chemical energy into electric energy. In a fuel cell, the principle of electrolysis is reversed. Various types of fuel cells which generally differ from one another in terms of the operating temperature are now known. However, the structure of the cells is the same in principle in all types. They are generally made up of two electrode layers, an anode and a cathode, at which the reactions occur, and an electrolyte in the form of a membrane between the two electrodes. This membrane has three functions. It establishes ionic contact, prevents electronic contact and also keeps the media supplied to the electrode layers separate. The electrode layers are generally supplied with gases or liquids which are reacted in a redox reaction. For example, the anode is supplied with hydrogen or methanol and the cathode is supplied with oxygen. To achieve this, the electrode layers are usually contacted by means of electron-conducting gas diffusion layers. These are, for example, plates having a lattice-like surface structure made up of a system of fine channels. The overall reaction can be divided into an anodic substep and a cathodic substep in all fuel cells. As regards the operating temperature, the electrolyte used and the possible fuels, there are differences between the various types of cell.

According to the present-day state of the art, all fuel cells have gas-permeable, porous, three-dimensional electrodes. These are referred to by the collective term gas diffusion electrodes (GDEs) and comprise the gas diffusion devices and the electrode layer. The respective reaction gases are conducted through the gas diffusion layers to close to the membrane, viz. the electrolyte. Adjoining the membrane, there are electrode layers in which catalytically active species which catalyze the reduction or oxidation reaction are generally present. The electrolyte which is present in all fuel cells ensures transport of charges in the form of ions in the fuel cell. It has the additional function of forming a gastight barrier between the two electrodes. In addition, the electrolyte guarantees and helps to maintain a stable 3-phase layer in which the electrolytic reaction can take place. The polymer electrolyte fuel cell uses organic ion-exchange membranes, in industrially realized cases perfluorinated cation-exchange membranes in particular, as electrolytes. A unit which is generally made up of a membrane and two electrode layers which each adjoin one side of the membrane is referred to as membrane-electrode assembly (MEA).

Catalysts which comprise an alloy of at least two different metals of which at least one metal is a metal of transition group VIII are used, for example, as electrocatalysts in fuel cells. Such catalysts are particularly suitable for use as cathode catalyst in direct methanol fuel cells (DMFCs). Apart from a high current density for the reduction of oxygen, cathode catalysts in DMFCs have to meet further requirements. In operation of a DMFC, the diffusion of methanol through the membrane to the cathode (crossover) occurring when a fuel cell is operated using organic, water-soluble fuels is problematical. As a result, the organic molecule is burnt directly by means of oxygen to form carbon dioxide and water at the catalytically active site of the cathode catalyst. The active sites occupied by the combustion of organic molecules are no longer available for the actual electrochemical reaction, viz. the electrochemical reduction of oxygen, so that the total activity of the cathode layer decreases. In addition, the direct oxidation of the organic molecule by means of oxygen reduces the electrochemical potential of the cathode layer and the total voltage which can be taken off from the fuel cell is reduced. Since reduction of oxygen and oxidation of the organic molecule occur at the same electrochemically active site, this results in formation of a mixed potential which is lower than that of the reduction of oxygen. The driving force (EMF) is reduced and the total cell voltage and thus the power are decreased. The cathode catalyst used therefore has to be very inactive in respect of the oxidation of methanol. This means that it has to have a high selectivity for the reduction of oxygen over the oxidation of methanol.

Heat-treated porphyrin-transition metal complexes, as are known from J. Applied Electrochemistry (1998), pages 673-682, or transition metal sulfides, for example ReRuS or MoRuS systems as are known, for example, from J. Electrochem. Soc., 145 (10), 1998, pages 3463-3471, have, for example, a high current density for the reduction of oxygen and display good tolerance toward methanol. However, these catalysts do not achieve the activity of Pt-based catalysts and are also not stable enough to ensure a satisfactory current density over a prolonged period in the acid medium of a fuel cell.

It is known from US-A 2004/0161641 that Pt catalysts which are alloyed with transition metals display good methanol tolerance and ensure a sufficiently high current density for the reduction of oxygen. Thus, US-A 2004/0161641 discloses, for example, that an active methanol-tolerant cathode catalyst should have a very high binding energy for oxygen and at the same time a low binding energy for hydrogen. A high binding energy for oxygen ensures a high current density for the reduction of oxygen, while a low binding energy for hydrogen decreases the electrooxidative dehydrogenation of methanol to carbon monoxide and thus increases the methanol tolerance. These properties are, according to US-A 2004/0161641, displayed by alloys of the elements Fe, Co, Ni, Rh, Pd, Pt, Cu, Ag, Au, Zn and Cd. However, a specific example of an alloy composition which is suitable as a methanol-tolerant cathode catalyst is not given.

As an alternative to the use of a methanol-tolerant catalyst, Platinum Metals Rev. 2002, 46, (4), for example, mentions the possibility of reducing methanol crossover by choice of a more suitable membrane. For this purpose, it is possible to use, for example, thicker Nafion membranes. However, the lower methanol crossover leads at the same time to an increase in the membrane resistance, which ultimately leads to a decrease in power of the fuel cell.

It is an object of the present invention to provide a catalyst which is suitable for the cathodic reduction of oxygen in methanol fuel cells and is sufficiently stable in the acidic medium of the fuel cell and very insensitive to methanol contamination. A further object of the invention is to provide a process for producing the catalyst.

The object is achieved by a catalyst comprising an alloy of at least two different metals of which at least one metal is a metal of transition group VIII. The alloy is present in at least two phases having different degrees of alloying.

An alloy is a homogeneous, solid solution composed of at least two different metals, with one element being referred as base element and the others being referred to as alloying elements. The base element is the element which is present in the greatest proportion by mass in the alloy. In the case of alloys comprising the same base element and the same alloying elements, different phases result from a different composition. Thus, the proportion of the alloying elements in the base element is different in the individual phases. It is sometimes even possible for the proportion of the base element to be smaller than the proportion of at least one alloying element in a particular phase.

In a preferred embodiment, the catalyst comprises an alloy of two different metals, where at least one of the two metals is a metal of transition group VIII of the Periodic Table of the Elements according to the old designation.

The metal of transition group VIII preferably forms the base element of the alloy. Suitable metals of transition group VIII are iron, cobalt, nickel, ruthenium, rhodium, palladium, osmium, iridium and platinum. The base metal of the alloy is particularly preferably platinum or palladium.

In the case of alloys which consist of two different metals, preference is given to both metals being elements of transition group VIII of the Periodic Table of the Elements. The alloy present in the catalyst is particularly preferably selected from the group consisting of PtCo, PtNi, PtFe, PtRu, PtPd, PdFe.

According to the invention, the alloy is composed of at least two phases having different degrees of alloying. The individual phases in each case form metal crystallites which are present side-by-side in a disordered arrangement. The result is a heterogeneous microstructure composed of metal crystallites of the individual phases of the alloy.

The catalyst having the structure according to the invention and comprising the alloy of at least two different metals which is composed of at least two phases having different degrees of alloying is stable toward acids and displays a high current density for the reduction of oxygen, as is desired in direct methanol fuel cells. In addition, the catalyst having the structure according to the invention is also very tolerant toward methanol contamination.

To achieve a sufficiently good catalytic activity, it is necessary for the catalyst to have a large specific surface area. This is preferably achieved by the catalyst further comprising a support, with the alloy being applied to the support or being mixed heterogeneously with the support. To achieve a large surface area, it is preferred that the support is porous.

When the catalyst is heterogeneously mixed with the support, individual catalyst particles are distributed in the support material. When the catalyst is applied to the support, individual particles of the catalyst material are generally present on the support surface. The catalyst is usually not present as a continuous layer on the support surface.

Suitable supports are, for example, ceramics or carbon. A particularly preferred support material is carbon. The advantage of carbon as support material is that it is electrically conductive. When the catalyst is used as electrocatalyst in a fuel cell, e.g. as cathode of the fuel cell, it is necessary for this to be electrically conductive in order to ensure the function of the fuel cell.

Further suitable support materials are, for example, tin oxide, preferably semiconducting tin oxide, γ-aluminum oxide, which may be coated with carbon, titanium dioxide, zirconium dioxide, silicon dioxide, with the latter preferably being present in finely divided form in which the primary particles have a diameter of from 50 to 200 nm.

Other suitable support materials are tungsten oxide and molybdenum oxide, which can also be present as bronzes, i.e. as substoichiometric oxide. Carbides and nitrides of metals of transition groups IV to VII of the Periodic Table of the Elements, preferably carbides and nitrides of tungsten and of molybdenum, are also suitable.

When carbon is used as material for the support, this is preferably present in the form of carbon black or graphite. As an alternative, the carbon can also be present as activated carbon or as nanostructured carbon. A representative of nanostructured carbons are, for example, carbon nanotubes.

To produce an electrode of a fuel cell, in particular a cathode of a fuel cell, a catalyst layer is applied either to the membrane or to the gas diffusion layer. The catalyst layer is applied by techniques known to those skilled in the art. Suitable techniques are, for example, printing, spraying, doctor blade coating, rolling, brushing and painting. In addition, the catalyst layer can be applied by physical vapor deposition (PVD), chemical vapor deposition (CVD) or sputtering. A “decal” process in which the catalyst layer is firstly prepared on a “release” film and subsequently delaminated onto the membrane can also be used. The application is carried out using, in a manner analogous to the direct application of the catalyst layer to the polymer electrolyte membrane, a homogenized ink which generally comprises at least one catalytically active species is appropriate, if appropriate applied to a suitable support, at least one ionomer and at least one solvent. Suitable solvents are water, monohydric and polyhydric alcohols, nitrogen-comprising polar solvents, glycols and also glycol ether alcohols and glycol ethers. Particularly suitable solvents are, for example, propylene glycol, dipropylene glycol, glycerol, ethylene glycol, hexylene glycol, dimethylacetamide, N-methylpyrrolidone and mixtures thereof.

In a preferred embodiment, the phases forming the alloy are cubic phases having different lattice constants. The lattice constant is the mean spacing of the atoms at the corners of the cubic lattice which forms the cubic phase. Since different metal atoms can have a different diameter, the lattice constants are different for differing compositions of the alloy. In this way, the different phases can also be characterized.

The crystallite size of the individual phases is preferably in the range from 1 to 10 nm, particularly preferably from 2 to 5 nm.

In a particularly preferred embodiment, the alloy present in the catalyst is a PtCo alloy. The phases of the PtCo alloy preferably have lattice constants of 0.388 nm and 0.369 nm. At a lattice constant of 0.388 nm, the proportion of Co in the alloy is about 11 atom percent. The proportion of Co in the alloy having a lattice constant of 0.369 nm is about 41±5 atom percent.

The further object is achieved by a process for producing a catalyst comprising an alloy of at least two different metals of which at least one metal is a metal of transition group VIII, which comprises the following steps:
(a) deposition of at least one further metal on the metal of transition group VIII,
(b) heat treatment to form an alloy at a temperature above the Tammann temperature and below the melting point of the alloy.

As a result of the heat treatment of the alloy at a temperature above the Tammann temperature and below the melting point, the individual atoms within the metal lattice of the alloy have sufficient mobility to be able to undergo reorientation. In this way, it is possible for individual atoms to leave their lattice sites and change places with other atoms.

The Tammann temperature is the temperature at which the atoms within the lattice have sufficient mobility to be able to undergo reorientation. The Tammann temperature is usually from about 30 to 50% of the melting point of the alloy.

As a result of the heat treatment at a temperature above the Tammann temperature and below the melting point, individual atoms in the solid metal can undergo reorientation so as to form a new metal phase.

Preference is also given to the temperature selected for heat treatment of the alloy being below the stability limit of the at least two phases having different degrees of alloying which are to be formed by means of the process according to the invention. In order for it to be possible for the two different phases to form, it is necessary, during formation of the alloy, for the proportion of the alloying element to be greater than the proportion of the alloying element in the phase having the small proportion of the alloying element but to be smaller than the proportion of the alloying element in the phase having the greater proportion of the alloying element. The ratio of the phases relative to one another can likewise be set via the proportion of the alloying element in the alloy formed.

Formation of the alloy is carried out by any method known to those skilled the art. For this purpose, the at least one further metal is firstly deposited on the metal of transition group VIII. The deposition of the at least one further metal can, for example, be carried out in solution. For example, metal compounds can for this purpose be dissolved in a solvent. The metal can be covalently bound, ionically bound or be complexed. The metal can, for example, be deposited reductively or in an alkaline medium by precipitation of the corresponding hydroxide. Further possibilities for deposition of the at least one further metal are impregnation with a solution comprising the metal (incipient wetness), chemical vapor deposition (CVD) or physical vapor deposition (PVD) processes and also all further processes known to those skilled in the art by means of which a metal can be deposited.

When a support is provided, preference is given to the base element, i.e. the metal of transition group VIII, being deposited on the support first. This is preferably likewise carried out as described above for the at least one further metal. Preference is given to firstly precipitating a salt of the base element and subsequently precipitating a salt of the alloying element. Precipitation is followed by drying and thermal treatment to form the alloy. It is possible for the thermal treatment to be combined with the heat treatment in step (b).

In a preferred embodiment, the deposition of the further metal on the metal of transition group VIII in step (a) is carried by precipitation of a corresponding metal salt from a solution in the presence of a support. The heat treatment at a temperature below the melting point in step (b) forms the alloy.

To remove the solvent of the solution, the catalyst is preferably filtered off from the solution after precipitation and is washed. Drying in the presence of a protective gas or under reduced pressure further reduces the remaining water content of the solvent, typically to less than 5% by weight. A pulverulent catalyst precursor is formed.

As solvent in which the precipitation is carried out, it is possible to use any suitable solvent. It is only necessary to ensure that the salts of the metals which form the alloy dissolve in the solvent. Water is preferred as solvent. Alcohols, in particular ethanol, effect reduction of, for example, platinum. When cobalt is used, the precipitation is likewise carried out in aqueous solution, but unlike platinum preferably by means of alkali and not reductively.

The protective gas in whose presence drying is carried out is preferably nitrogen or argon. Drying under reduced pressure is also possible. When drying under reducing conditions is desired, drying is generally carried out under a hydrogen atmosphere. The hydrogen can in this case be present either in pure form or as a mixture with nitrogen or argon.

To reduce the metal salts which have been precipitated to form the desired alloy, the heat treatment step is preferably carried out in the presence of hydrogen. However, it is also possible to carry out the heat treatment step in the presence of nitrogen. To produce an alloy of platinum and cobalt, preference is given to using Pt(NO₃)₂ as salt of the first metal and Co(NO₃)₂ as salt of the second metal. To produce the catalyst comprising the alloy of platinum and cobalt, preference is given to introducing carbon black as carbon support into water in a first step. A solution of Pt(NO₃)₂ in water and ethanol is combined with the carbon black suspension. The resulting reaction mixture is then stirred and subsequently heated. This results in precipitation of platinum on the carbon. The platinum precipitated on the carbon is filtered off and subsequently washed with water until free of nitrate. It is finally dried under a nitrogen atmosphere.

The resulting carbon with the platinum precipitated thereon is subsequently introduced into water. A mixture of Co(NO₃)₂*6H₂O dissolved in water is added to this suspension. The pH is kept constant by addition of a sodium carbonate solution. Cobalt precipitates on the platinum-laden carbon. The solid is filtered off and subsequently dried under a nitrogen atmosphere. To produce an alloy on the carbon support, the solid is subsequently treated at elevated temperature. The temperature is preferably above the Tammann temperature of the alloy. The heat treatment is preferably carried out in the presence of nitrogen and hydrogen. The heat treatment is preferably followed by passivation at room temperature in the presence of a nitrogen and air atmosphere.

To remove excess cobalt which is not stable to acid, the thermally treated catalyst is preferably slurried in sulfuric acid and stirred under a nitrogen atmosphere. Preference is given to using from 0 to 1 M, more preferably from 0.4 to 0.6 M, sulfuric acid for slurrying. The temperature is in the range from 60 to 100° C., preferably from 85 to 95° C. The catalyst is finally filtered off with suction from the solution and dried under reduced pressure.

The catalyst produced according to the invention is suitable, for example, for use as electrode material in a fuel cell. Suitable application areas here are the electrooxidation of methanol or hydrogen and/or the electroreduction of oxygen. The catalyst of the invention can also be employed for other electrochemical processes such as chloralkali electrolysis and the electrolysis of water. The catalyst of the invention can, for example, also be used in automobile exhaust catalysts, for example as 3-way catalyst or diesel oxidation catalyst, or for catalytical hydrogenation or dehydrogenation in the chemical industry. Such reactions include, hydrogenations of unsaturated aliphatic, aromatic and heterocyclic compounds, the hydrogenation of carbonyl, nitrile, nitro groups and of carboxylic acids and esters thereof, aminative hydrogenations, hydrogenations of mineral oils and carbon monoxide. As examples of dehydrogenations, mention may be made of the dehydrogenation of paraffins, of naphthenes, of alkylaromatics and of alcohols. The hydrogenation or dehydrogenation can be carried out either in the gas phase or in the liquid phase.

In a particularly preferred embodiment, the catalyst of the invention is used for an electrode in a direct methanol fuel cell. The electrode for which the catalyst is used is, in particular, a cathode of the direct methanol fuel cell. When used as cathode of a direct methanol fuel cell, the catalyst of the invention displays a high current density for the reduction of oxygen. In addition, the catalyst of the invention is tolerant toward methanol contamination. This means that the catalyst of the invention is essentially inactive in respect of the oxidation of methanol. Thus, it has been found that the current density for the reduction of oxygen drops by less than 5% in the presence of 0.1 M methanol, while the current density for the reduction of oxygen over a catalyst in which the alloy is present as only a single phase sometimes decreases by more than 50% in the presence of methanol.

### EXAMPLES

### Example of Production of a Catalyst

### a) Precipitation of Platinum on Carbon (Pt/C)

75 g of carbon black of the grade EC300J were introduced into 3.5 l of water, the mixture was homogenized by means of an UltraTurrax T25 at 110 000 rpm for 2 minutes and subsequently stirred by means of an IKA stirrer with double stirrer for 13 minutes. 130 g of Pt(NO₃)₂ were subsequently dissolved in 1.5 l of water and mixed with 5 l of ethanol. This solution was combined with the carbon black suspension to produce a reaction mixture. The reaction mixture was subsequently stirred at room temperature for 30 minutes and then refluxed for 5 hours. The Pt/C formed was filtered off and washed with 242 l of water for 16 hours until free of nitrate. It was finally dried in a rotary tube furnace at 100° C. for 54 hours under a nitrogen atmosphere with a throughput of 50 l/h of nitrogen.

### b) Production of a Mixture of Platinum and Cobalt on Carbon (PtCo/C)

16 g of the Pt/C material produced above were introduced into 1.5 l of water and stirred for 30 minutes. 20 g of Co(NO₃)₂*6H₂O dissolved in 50 ml of water were subsequently added. The pH of this mixture is kept constant at 5.6 by addition of a 5% strength sodium carbonate solution. After addition of the Co(NO₃)₂, the mixture was stirred at 60° C. with introduction of air for one hour, resulting in the pH dropping to 4.3. After one hour, the pH was set to 7.5 by means of a 5% strength sodium carbonate solution. The PtCo/C was subsequently filtered off and washed with 12 l of water to free it of nitrate. It was then dried in a rotary tube furnace at 100° C. for 16 hours under a nitrogen atmosphere with a nitrogen volume flow of 50 l/h.

This material will hereinafter be referred to as ES 271.

### Heat Treatment

4 g of the PtCo/C material ES 271 were brought to 600° C. in a rotary tube furnace over a period of 3 hours and maintained at this temperature for 3 hours. During this heat treatment, the sample was flushed with 5 l/h of nitrogen and 10 l/h of hydrogen, with the addition of nitrogen and hydrogen occurring simultaneously. After the heat treatment, the sample was passivated at room temperature by means of 15 l/h of N₂ and 3 l/h of air. For this purpose, the rotary tube furnace was firstly flooded with pure nitrogen to remove the hydrogen completely from the furnace and air was subsequently added to the nitrogen.

To remove excess Co which is not stable to acid, the thermally treated catalyst was subsequently slurried with 0.5 M H₂SO₄ and stirred at 90° C. under nitrogen for one hour. The catalyst was subsequently filtered off with suction and dried under reduced pressure.

The catalyst produced in this way was examined by X-ray diffraction. The diffraction pattern displays double lines at 40.3° and 41.7°, at 46.3° and 48.5°, at 68.2° and 71.4° and at 82.3° and 86.6°. The crystallite size and the lattice constants of the two phases can be determined from the diffraction pattern, giving the following results:

Phase 1: Crystallite size: 3.0 nm; lattice constant: 0.388 nm
Phase 2: Crystallite size: 8.4 nm; lattice constant: 0.369 nm

This material will hereinafter be referred to as ES 294.

### 1. Comparative Example for Production of a Catalyst

As an alteration to the above-described production of the catalyst according to the invention, the PtCo/C material ES 271 was heat treated not at 600° C. but under otherwise identical conditions at 400° C. In this case, it was found that no double phase occurs. The crystallite size of the single phase formed is 2.9 nm and the lattice constant is 0.389 nm.

This catalyst, too, was slurried with 0.5 M H₂SO₄ after the thermal treatment and stirred at 90° C. under nitrogen for one hour. The catalyst was finally filtered off with suction and dried. The material produced in this way will hereinafter be referred to as ES 275. Unlike the catalyst ES 294 according to the invention, the diffraction pattern of ES 275 displays only single lines and no occurrence of double lines. It can be concluded from this that the material which has been heat treated at 400° C. is composed of only a single phase.

### 2. Comparative Example for Production of a Catalyst

Part of the catalyst ES 294 which had been produced according to the invention as described in the example of production of a catalyst was repeatedly slurried with sulfuric acid and stirred at 90° C. for one hour. After each acid treatment, the catalyst was filtered off with suction, dried and the phase composition of the PtCo metal was examined by means of X-ray diffraction. After having been treated three times with acid, the material no longer displayed the characteristic double lines in the X-ray diffraction pattern. The material thus has only the phase referred as phase 1 in the example of production of a catalyst. Phase 2 had been completely leached from the material by the repeated acid treatment.

This material with phase 2 leached out will hereinafter be referred to as ES 297.

The X-ray diffraction pattern shows that no double lines but only single lines now occur in the material ES 297.

### Methanol Tolerance

The catalysts ES 275, ES 294, ES 297 produced according to the example of production of a catalyst and the two comparative examples were each processed to produce an ink. For this purpose, 6 mg of the catalyst, 1 g of 5% strength Nafion solution and 7.07 g of isopropanol were mixed in each case. 200 μl of this ink were applied in 20 μl portions to a measuring head having a cross-sectional area of 100 mm², a 3-electrode arrangement with a calomel reference electrode on an annular disk electrode and dried by means of a hair drier. The experiments on methanol tolerance were carried out in 1 M H₂SO₄ at 70° C. The electrolyte was saturated with oxygen for one hour before commencement of the measurement. To bring the catalyst layers to a defined initial state, two cyclovoltammetric scans from −150 mV to 850 mV and back to −150 mV against calomel at an increase rate of 50 mV/sec and a rotational speed of 600 rpm were carried out before the actual measurement. For the actual measurement, the electrode potential of the working electrode against the calomel electrode was kept constant at 500 mV and the cathode current was recorded as a function of time. The average current density standardized to the noble metal content between 1700 and 1710 sec after commencement of the experiment served as a measure of the current density for the reduction of oxygen over the catalysts examined. To examine the influence of methanol, the experiment was firstly carried out in a pure sulfuric acid electrolyte and subsequently in a methanol-comprising electrolyte comprising 3 mM of methanol.

The current densities measured for the reduction of oxygen over the three catalysts produced are shown in Table 1.

TABLE 1
Current densities for the reduction of oxygen over the three catalysts

| | O₂ reduction current | O₂ reduction current (500 mV |
|---|---|---|
| | (500 mV v NCE) without | v NCE) with 0.1M MeOH, |
| Catalyst | MeOH, mA/mg of Pt | mA/mg of Pt |
| ES275 PtCo/C | −17.81 | −10.69 |
| ES294 PtCo/C | −43.30 | −42.00 |
| ES297 PtCo/C | −29.26 | −11.12 |

It can be seen from the experiment that the current density for the reduction of oxygen over the catalyst produced according to the invention is more than twice as high as in the case of a catalyst which has not been heat treated and is also more than 30% greater than in the case of a catalyst from which the second phase has been leached out. Furthermore, the measured O₂ reduction currents in a solution without methanol and in a solution comprising 0.1 M methanol are not significantly different in the case of the catalyst according to the invention, while a decrease in the current density of about 40% is observed in the case of the catalyst which has not been heat treated and a decrease of about 62% is observed in the case of the catalyst from which one phase has been leached out.

1-14. (canceled)

15. A catalyst comprising an alloy selected from the group consisting of PtCo, PtNi, PtFe, PtRu, PtPd, PtCu and PdFe, wherein the alloy is present in at least two phases having different degrees of alloying, wherein the individual phases in each case form metal crystallites which are present side-by-side in a disordered arrangement by which a heterogeneous microstructure composed of metal crystallites of the individual phases of the alloy results, wherein the crystallite size of the individual phases is in the range from 1 to 10 nm.

16. The catalyst according to claim 15, wherein the catalyst further comprises a support, with the alloy being applied to the support or being mixed heterogeneously with the support.

17. The catalyst according to claim 16, wherein the support is a carbon support.

18. The catalyst according to claim 15, wherein the phases are cubic phases having different lattice constants.

19. The catalyst according to claim 15, wherein the alloy is a PtCo alloy in which the phases have lattice constants of 0.388 nm and 0.369 nm.

20. A process for producing a catalyst comprising an alloy selected from the group consisting of PtCo, PtNi, PtFe, PtRu, PtPd, PtCu and PdFe according to claim 15, which comprises:
a. formation of an alloy from the metals being alloyed by sequential precipitation of salts of the metals which form the alloy from a solution in the presence of a support, and
b. heat treatment of the alloy at a temperature above the Tammann temperature and below the melting point of the alloy in the presence of nitrogen and hydrogen.

21. The process according to claim 20, wherein drying in the presence of a protective gas is carried out after precipitation.

22. The process according to claim 21, wherein the protective gas is N₂.

23. The process according to claim 20, wherein the salt of the first metal is Pt(NO₃)₂ and the salt of the second metal is Co(NO₃)₂.

24. The catalyst according to claim 15, wherein the catalyst comprises an electrode material in a fuel cell.

25. The catalyst according to claim 24, wherein the fuel cell is a methanol fuel cell.

26. The catalyst according to claim 24, wherein the electrode for which the catalyst is used is a cathode.
